(19) United States
(12) Patent Application Publication
(10) Pub. No.: US 2003/0141839 A1
(43) Pub. Date: Jul. 31, 2003

(54) Power King

(76) Inventor: Andre E. Hinckson, St. Albans, NY (US)

Correspondence Address: Andre Hinckson, 114-47 196 Street, St. Albans, NY, 11412, US

(21) Appl. No.: 10/055,695

(22) Filed: Jan. 25, 2002

(51) Int. Cl. H02J 7/00

(52) U.S. Cl. 320/107

(57) ABSTRACT

A portable electronic device that is used as a backup power supply. Which provides a more convenient, effecient and economical way of obtaining a variety of electrical current, without the use of fuel, day or night.

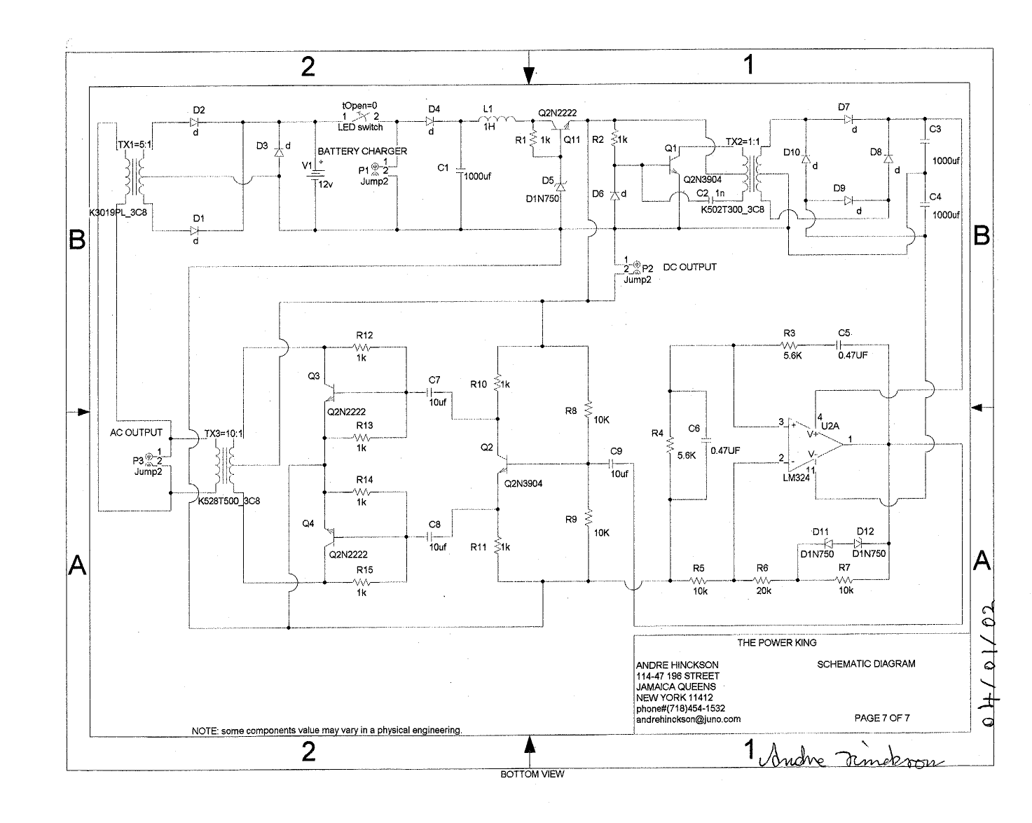

The Power King has a 12 volts rechargeable battery, which initially acts like the starter in an automobile. When the Power King is turned on, it's battery activates the regenerative circuit, thus allowing the battery self-charging system to be energized. The regenerative circuit contains a set of feadback circuits which uses the following electronic devices in its operation.

(1) An Electrical inverter: This device inverts the DC (direct current) from the battery into an AC (alternating current), which is suitable for home equipment uses.

(2) An Electrical converter: This device converts the AC to DC, for use in today's “high tech” battery operated devices, and also helps to power the regenerative circuit.

(3) A Battery charger: This device is used for recharging the battery, and can be used for recharging other identical batteries. These electronic devices are connected in a series/parallel configuration to partly produce a replica current source of the battery.

### A DETAILED DESCRIPTION OF THE DRAWING

The battery is connected from the battery charger to the on/off switch, which contains a light emitting diode that eliminates when the device is on. The on/off switch is connected to the converter through a blocking diode. This will prevent current leakage from the converter to the battery. The converter contains a 1000 uf capacitor, a coil and a 12 volts voltage regulator. The converter is connected to the inverter, which contains a dual polarity 12 volts power supply, a 60 hertz sine wave oscilator, and a 120 volts- 15 amps class B power amplifier. The inverter is connected to the battery charger, which also contains a fast recovery diode connceted in a reverse bias mode. This will help to prevent wrong battery connections, when replacing or recharging the battery. Note: fuses are used at each output to prevent circuit overloads.

### CROSS-REFERENCES TO RELATED APPLICATIONS

Unlike the electrical generater, solar cells or any other backup power supplies, the Power King is an electronic device that produces a variety of electrical current without the use of fuel, day or night.

### FIELD OF THE INVENTION

Electrical current producing device.

### BACKGROUND OF THE INVENTION

Due to the supply and demand of electrical energy, the Power King was invented to provide a more convenient, effecient and economical way of providing electrical energy.

### SUMMARY

They are many types of backup power supplies and electrical current producing devices, but the Power King is the only electrical device that produces electrical energy wihtout the use of fuel, in the day or in the night. Thus illiminating air, land and noise pollution

In conclusion the power king works because it uses the regenerative principle. This type of configuration allows the battery to supply a substantional amount of current to the feadback circuits yet partly recharging itself, due to a combination of positive and negative feadback from the battery charger to the battery.

1. (what) I claim that the power king is an electronic device that produces a variety of electrical current without the use of fuel, day or night:

2. (why) To provide a more convenient, effecient and economical way of obtaining electrical energy.

3. (how) The Power King has a complex electronic circuit that works on a regenerative principle.

4. (where) The Power King is portable and can be operated in various temperature conditions, inside or outside a building.

5. (when) The Power King is available now, and is being modified.
